(19) United States
(12) Patent Application Publication
(10) Pub. No.: US 2006/0262937 A1
(43) Pub. Date: Nov. 23, 2006

(54) Audio reproducing apparatus

(75) Inventor: Shinji Kobayashi, Chiba (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/413,092

(22) Filed: Apr. 28, 2006

(30) Foreign Application Priority Data
May 18, 2005 (JP) 2005-145716

(51) Int. Cl. H04R 5/00

(52) U.S. Cl. 381/27

(57) ABSTRACT

An audio reproducing apparatus for reproducing audio signals of two or more channels including at least a left-channel audio signal and a right-channel audio signal, including: a mixing section, first to fourth delay sections for delaying an audio signal by a predetermined time, for supply to front left, front right, rear left, rear right speakers; wherein the center speaker is disposed frontward of the front left speaker and the front right speaker; the front left speaker and the front right speaker are disposed approximately symmetrical with respect to a centerline passing through the center speaker, at a first distance from the center speaker; and the rear left speaker and the rear right speaker are disposed approximately symmetrical with respect to the centerline at a second distance larger than the first distance, from the center speaker.

### BACKGROUND OF THE INVENTION

1. Technical Field

The present invention relates to a car audio reproducing apparatus for reproducing and outputting, e.g., data on music media.

2. Background Art

Various car audio apparatus have hitherto been proposed, which allow a user to enjoy listening to audio such as radio programs, music CDs (Compact Discs), DVDs (Digital Versatile Disks), inside a car while driving the car. In order to listen to a music CD or the like having data recorded thereon in stereo pleasantly, e.g., a 4-channel car audio apparatus is available, in which speakers are installed in front left (FL), front right (FR), rear left (RL), rear right (RR) positions as viewed from the front of the car, whereby stereo sound reproduction is implemented through audio reproduction using a car audio apparatus.

When listening to music or the like reproduced in stereo using a multi-channel audio apparatus, a listener is interested in a sound field and sound localization. The term “soundfield” is a concept used for creating a pseudo acoustic space by reproduced sounds, and a sound field space perceivable by the listener is called a virtual room size. Moreover, the term “sound localization” indicates that a sound image as a virtual sound source perceived by the listener during stereophonic sound reproduction occupies a certain position. And by adjusting sounds outputted from the rear speakers only for a short interval of time, with respect to the front speakers, the sounds can be located in front of the listener, and this is called “in-front localization”. Conventionally, such a technique of adjusting time axis for reproducing sounds in this way has been available to enhance sound quality matched with the listening position of a listener, particularly, sound localization.

Referring here to FIG. 4, an exemplary configuration of a conventional car audio apparatus will be described. In FIG. 4, the upper part indicated by an arrow F is the front of a car 3, and the lower part indicated by an arrow R is the rear of the car 3. Here is a case where the car 3 incorporates a conventional car audio apparatus 10 capable of 2-channel stereo reproduction. In this case, audio signals for reproduction and output from respective speakers are timed for each listener position. Specifically, using the seat of a listener as a reference, correction is made by adjusting time axis in terms of its distance from the surrounding speakers. That is, e.g., it is supposed that a listener 5 aboard the car 3 sits in a front right seat facing the front and is listening to sounds from the speakers. In the car 3, there are installed four speakers 1FL, 1FR, 1RL, 1RR for outputting sounds overall in front left, front right, rear left, rear right positions, respectively. Moreover, the speakers 1FL to 1RR are connected to speaker connection terminals of the car audio apparatus 10, to output sounds from, e.g., a music CD and the like. The front left and rear left speakers 1FL and 1RL are arranged to output a left-channel audio signal, and the front right and rear right speakers 1FR and 1RR are arranged to output a right-channel audio signal.

Distances between the listener 5 and the speakers 1FL, 1FR, 1RL, 1RR are now set to a1 to a4, respectively. When the speakers are installed in this way, in order for the listener to feel a virtual room size, adjustment needs be made, by using the distance between the listener 5 and any one of the speakers as a reference, to introduce delay to sounds from the other speakers. For example, in order to maximize the virtual room size, adjustment is made by using the output timing of the farthest speaker (e.g., the speaker 1RL) as a reference. If time delay according to which each of the speakers 1FL, 1FR, 1RR outputs sound is to be adjusted, the speakers 1FL, 1FR, 1RR are virtually installed as if they were positioned as virtual speakers 1FL′, 1FR′, 1RR′, which are at the same distance, a3, as the distance between the speaker 1RL and the listener 5. By arranging in this way, there is formed a substantially circular virtual room size 7 having a radius a3 around the listener 5, providing a listening area 6 enabling ideal listening near the listener 5.

In Japanese Patent Application Publication H01-220599 (FIG. 1), a sound field configuration technique of this type designed for car rooms is disclosed.

### SUMMARY OF THE INVENTION

By the way, an ideal listening position is the center of a virtual room. In the conventionally employed technique for implementing the virtual room size by time axis adjustment for each speaker, it is not always possible for the listeners or seats to be positioned in the center of the virtual room size. That is, sound quality variations occur from one seat to another. In order to suppress these variations, the virtual room size needs to be designed for each seat. However, even if a virtual room size is designed such that its center coincides with a central position almost equidistant from all the seats, there is a limit in making the virtual room size larger than the distance between the central position of that seat and any of the speakers. That is, since the conventional method uses the distance between any of the speakers and the seat which would be the center of the virtual room size, as a reference, the virtual room size cannot be made larger than this distance no matter how properly the time axis may be adjusted. As a result, any distance between the actual seat positions comes to approximate to the radius of the virtual room size, making it difficult to provide the same sound quality to all the seats.

In the conventional technique, each of the listener positions is used as a reference, and thus except for the listener located at the center of the virtual room size, the sound quality achieved is sacrificed. Moreover, there is a limit in virtual room sizes that can be designed, and this prevents all the listeners from being placed in the center of the acoustically best virtual room size simultaneously. For example, if two listeners sit in left and right seats simultaneously, a problem has been addressed that they cannot obtain the required sound quality at their own seats.

Furthermore, due to the sound field differing from one seat to another, sound quality adjustment and setting tailored to each listening position need to be made. Thus, if a listener changes his/her seat position, it is difficult for him/her to obtain the required sound quality unless the current setting is altered such that the changed seat position will be located in the center of the virtual room size. Furthermore, in order to force in-front localization, the output of amplifiers disposed in the rear needs to be reduced, which has imposed another problem that the output of the amplifiers is difficult to be fully utilized. Still more, since the virtual room size is set for each seat, sound localization is uncertain for any listener who is not in the center of the virtual room size.

The present invention has been made in view of such circumstances, and has an object therefore to improve sound localization irrespective of the position of a listener.

The present invention provides an audio reproducing apparatus for reproducing audio signals of two or more channels including at least a left-channel audio signal and a right-channel audio signal. In the audio reproducing apparatus, there are provided a mixing section for mixing the left-channel audio signal and the right-channel audio signal, for supply to a center speaker; a first delay section for delaying the left-channel audio signal by a first delay time, for supply to a front left speaker; a second delay section for delaying the left-channel audio signal by a second delay time, for supply to a rear left speaker; a third delay section for delaying the right-channel audio signal by the first delay time, for supply to a front right speaker; a fourth delay section for delaying the right-channel audio signal by the second delay time, for supply to a rear right speaker. The center speaker is disposed frontward of the front left speaker and the front right speaker. The front left speaker and the front right speaker are disposed approximately symmetrical with respect to a centerline passing through the center speaker at a first distance from the center speaker. The rear left speaker and the rear right speaker are disposed approximately symmetrical with respect to the centerline at a second distance larger than the first distance, from the center speaker.

Under this configuration, a listener uses the audio signal outputted from the center speaker as a reference to adjust the timings for outputting the audio signals from the other speakers by setting the first and second delay times, whereby he/she can set an area where the audio signal from the center speaker reaches at a certain level, as a proper listening area, and then design the virtual room size freely.

According to the present invention, the virtual room size can be increased, and the listening area can also be expanded, whereby advantages are provided that consistent sound quality and sound localization can be achieved, and the listeners in all the seats can be located near the center of the listening area where sound quality can be enhanced.

### BRIEF DESCRIPTION OF THE DRAWINGS

FIG. 1 is a diagram showing an exemplary external configuration of a car audio reproducing apparatus in an embodiment of the present invention;

FIG. 2 is a block diagram showing an exemplary internal configuration of a car audio reproducing apparatus (for 2 channels) in an embodiment of the present invention;

FIG. 3 is a block diagram showing an exemplary internal configuration of a car audio reproducing apparatus (for 5 channels) in an embodiment of the present invention; and

FIG. 4 is a diagram showing an exemplary external configuration of a conventional car audio reproducing apparatus.

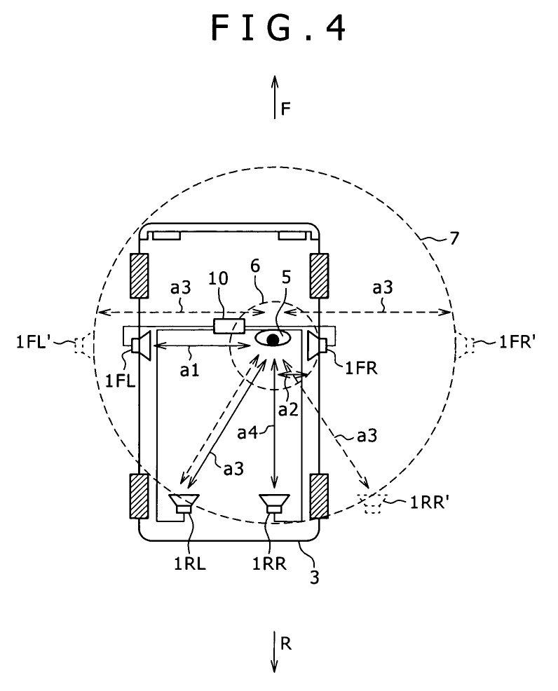

### DESCRIPTION OF THE PREFERRED EMBODIMENTS

An embodiment of the present invention will be described below with reference to the accompanying drawings. In the embodiment, the present invention is applied to a car audio reproducing apparatus that reproduces and outputs data on a music medium, such as a CD, a DVD.

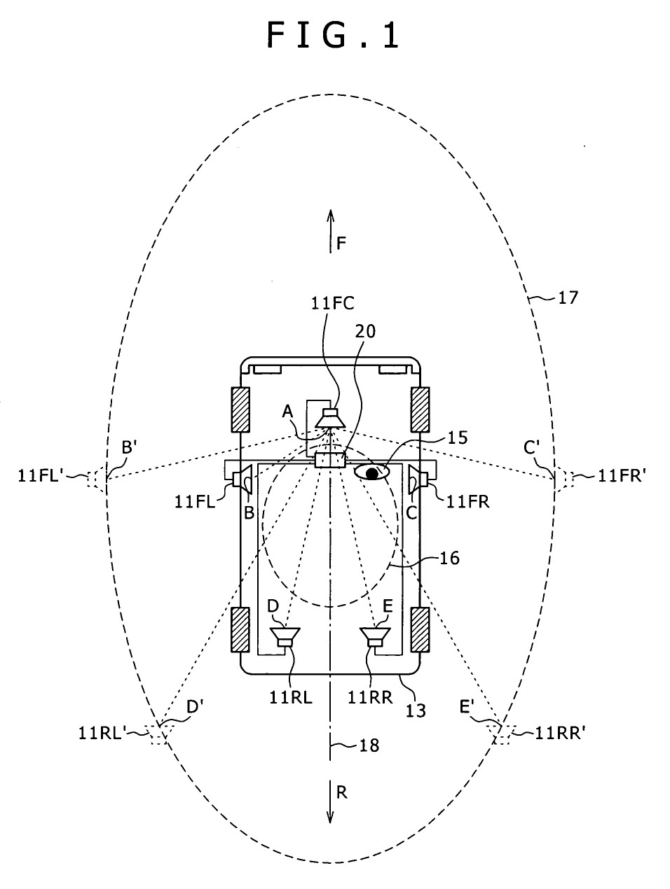

In this embodiment, the present invention is applied to a car audio apparatus for reproducing a 2-channel audio signal. Referring first to FIG. 1, an exemplary configuration of a car audio reproducing apparatus 20 according to the present embodiment will be described. In FIG. 1, the upper part indicated by an arrow F is the front of a car 13, and the lower part indicated by an arrow R is the rear of the car 13. In the present embodiment, it is supposed that a listener 15 aboard the car 13 sits in a front right seat facing the front and is listening to sounds from speakers. In the car 13, there are installed four speakers 11FL, 11FR, 11RL, 11RR for outputting sounds in front left, front right, rear left, rear right positions, respectively. The front left speaker 11FL and the front right speaker 11FR are installed in left and right doors of the car 13, respectively, and thus these speakers are positioned on both left and right sides of any person sitting in any front seat. The rear left speaker 11RL and the rear right speaker 11RR are installed in the rear of the car 13 in a manner facing frontward. These speakers 11FL, 11FR, 11RL, 11RR are configured as a so-called full-range speaker system having a substantially flat output characteristic within an audio frequency range. It may otherwise be configured as a hi-fi reproducing speaker system such as two-way speakers.

These speakers 11FL-11RR are connected to corresponding ones of speaker connection terminals of the car audio reproducing apparatus 20, to output sounds from, e.g., a music medium. And in the present embodiment, separately from these speakers, a time axis reference speaker 11FC is installed to the front of the listener 15 as a center speaker. The time axis reference speaker 11FC is used to output sounds from the front of the listener 15 in order to achieve in-front localization for the sounds. For example, it is disposed near a dashboard or a center console of the car 13. This time axis reference speaker 11FC may be any speaker unit capable of outputting a so-called medium frequency range above approximately 1-2 kHz which is important for humans to perceive a sense of position at least within the audio frequency range, and may also be small in structure. Moreover, it may have an output sensitivity inferior to the other speaker units. Here, a centerline 18 passing through the time axis reference speaker 11FC is set, and installation positions of the speakers 11FC, 11FL, 11FR, 11RL, 11RR are denoted by reference symbols A, B, C, D, E, respectively. The speakers are installed substantially symmetrical with respect to the centerline 18 such that AB=AC, AD=AE, respectively.

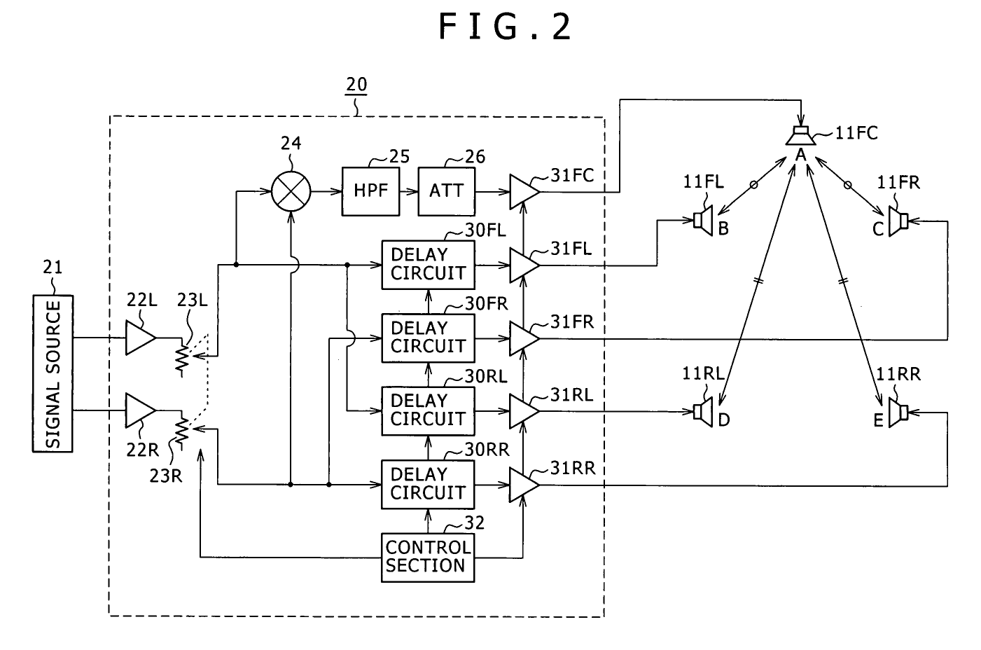

Referring next to FIG. 2, an exemplary internal configuration of the car audio reproducing apparatus of the present embodiment will be described. First, 2-channel reproducing audio signals from a music medium are fed from a signal source 21. A left audio signal is supplied to a preamplifier 22L, and a right audio signal is supplied to a preamplifier 22R. The left and right audio signals amplified by the preamplifiers 22L, 22R are supplied to volumes 23L, 23R for adjusting sound levels, respectively. The volumes 23L, 23R are conjunctionally controllable. The left and right audio signals adjusted by the volumes 23L, 23R are supplied to axis circuits for delaying the audio outputs by a predetermined time. Here, the left audio signal is supplied to delay circuits 30FL, 30RL, and the right audio signal is supplied to delay circuits 30FR, 30RR.

The audio signals which has been made to delay by the predetermined time by the delay circuits 30FL-30RR are supplied to amplifiers 31Fl-31RR for amplifying the respective signals for driving their speakers, and outputs from these amplifiers 31FL-31RR are supplied to the speakers 11FL-11RR connected to the speaker connection terminals (not shown) of the audio reproducing apparatus 20, for radiation as audio from the speakers 11FL-11RR. Therefore, it is configured such that the left-channel audio signal is outputted from the front left speaker 11FL and the rear left speaker 11RL, and the right-channel audio signal is outputted from the front right speaker 11FR and the rear right speaker 11RR. Although each of the delay circuits 30FL, 30FR, 30RL, 30RR can set its delay time variably according to virtual room size settings, it is basically arranged such that the delay circuits 30FL and 30FR for introducing delay to the signal for the front left speaker 11FL and the front right speaker 11FR are set to an equal first delay time, and such that the delay circuits 30RL and 30RR for introducing delay to the signal for the rear left speaker 11FL and the rear right speaker 11FR are set to an equal second delay time differing from the first delay time. Any delay time can be set to the delay circuits 30FL-30RR. Details of the delay times will be described later.

Moreover, the left and right audio signals supplied from the volumes 23L, 23R are mixed by a mixer 24, and the mixed (R+L) audio signal then supplied to a high-pass filter 25 which extracts a high frequency components. The high-pass filter 25 extracts, e.g., a frequency range exceeding 1-2 kHz which is important to human's sense of position. Note that a range exceeding 3 kHz may otherwise be used to suit the characteristics of the speakers used. And output of the high-pass filter is supplied to an attenuator 26 for attenuating the audio signal, to attenuate its signal level. The signal level at this point of process is set to a value which is, e.g., 3-6 dB lower than signal levels set for the speakers 11FL-11RR. The signal level is so set because if the signal level is not dropped, separation of the left and right signals deteriorates, to impair stereo acoustics, although the localization is improved. The output of the attenuator 26 is amplified for driving the speaker by an amplifier 31FC, and the amplified signal is supplied to the speaker 11FC connected to a corresponding one of the speaker connection terminals of the audio reproducing apparatus 20 for sound radiation. Here, it is a control section 32 that performs predetermined computation and control over sound level adjustment by the volumes 23, delay time settings by the delay circuits 30FL-30RR, amplification control for the amplifiers 31FC, 31FL-31RR. Since the time axis reference speaker 11FC is used as a later-described time reference, there is no need to operate the speaker 11FC at such a high output as the other speakers 11FL-11RR.

Referring here to FIG. 1, a technique for time axis adjustment for setting a virtual room size will be described. The car audio reproducing apparatus 20 according to the present embodiment uses an output audio signal from the time axis reference speaker 11FC as a reference for time axis. A human can recognize a position, not when sounds are being reproduced at a large volume in all ranges, but he/she recognizes a positional relationship, particularly, in-front localization, when sounds are being reproduced not at a large volume and without overlap with ambient sound. For this reason, the speaker 11FC is operated to produce output in real time. And by using a conventional technique of time axis correction (time delaying), time axis correction for the speakers 11FL, 11FR installed near the front doors is performed to match their distances from the time axis reference speaker 11FC. For doing so, it is set so that delay is introduced to the outputs of the speakers 11FL, 11FR by, e.g., 30-60 ms. However, their delay times are set so that their output timings coincide. When such delay is effected, virtual speakers 11FL′, 11FR′ are perceived with respect to the speakers 11FL, 11FR, whereby it is understood that a virtual room size 17 expands in a left-right direction as viewed from the listener 15. At this point, the installation positions of virtual speakers 11FL′, 11FR′, 11RL′, 11RR′ are denoted by reference symbols B′, C′, D′, E′, respectively. The virtual speakers are positioned substantially symmetrical with respect to the centerline 18 such that AB′=AC′, AD′=AE′, respectively.

Moreover, time axis processing for the speakers 11RL, 11RR installed in the rear of the car 13 is performed to match their distances from the time axis reference speaker 11FC. For doing so, it is set so that delay is introduced to the outputs of the speakers 11RL, 11RR by, e.g., 60-100 ms. However, their delay times are set so that their output timings coincide. When such delay is effected, virtual speakers 11RL′, 11RR′ are perceived with respect to the speakers 11RL, 11RR, whereby it is understood that the virtual room size 17 expands in a front-rear direction as viewed from the listener 15. That is, by increasing the amount of delay for the speakers 11FL-11RR, a larger virtual room size can be obtained. However, the amount of delay for the rear speakers 11RL, 11RR need to be larger than the amount of delay for the speakers 11FL, 11FR near the front doors.

By doing in this way, not a conventional time axis adjustment which is tailored to each listener seat and thus relative, but a positional relationship which uses the time axis reference speaker 11FC as a reference and thus absolute can be set, enabling the setting of a large virtual room size 17.

In the conventional technique, the distance between the listener and any of the speakers 11FL-11RR is used as a reference, and thus the virtual room size cannot be set to a value larger than this distance no matter how properly time axis may be adjusted. However, by using the time axis reference speaker 11FC according to the present embodiment, it becomes possible to increase the virtual room size. Moreover, since the listening area 16 can be expanded, the listeners in all the seats each can be put together near the center of the virtual room size. Thus, by setting a large virtual room size 17, the listening area 16 positioned near the center of the virtual room size 17 also becomes large. As a result, there is an advantage that the listener 15 can obtain a satisfactory sound field at any seat, and can hence listen to front-localized audio sounds. Consequently, there is no need to make adjustment for each listener seat.

Moreover, since the positions of all the seats can be set in the center of the virtual room size, a substantially similar front-localized sound quality can be realized at any seat. Furthermore, this is not a technique for setting in-front localization by volume adjustment, and thus does not need to force in-front localization. This means that the amplifiers for the rear speakers need not limit their outputs, and thus their sounds can be played at full volume.

Furthermore, sound quality enhancements for all the seats can be accomplished without involving any cumbersome operation such as setting the center of the virtual room size every time a listening seat is selected. That is, in the sound quality enhancement using the speaker 11FC as a time axis reference, any difference between left and right seats in terms of symmetric time axis data is eliminated. Conventionally, time axis adjustment in the left and right seats has been made involving both left and right speakers at the sacrifice of the sound quality at either of the seats. However, the present embodiment can provide an advantage that sound quality can be enhanced without sacrifice of the sound quality at any of the left and right seats. Since the time axis reference can be set as the absolute position, in-front localization can easily be realized, and thus, by installing the time axis reference speaker behind the dashboard, its effect can further be enhanced.

Thus, the time axis reference speaker 11FC neither needs to be driven at such a high output than the speakers 11FL-11RR by dropping its output, nor needs to have a wide output range, and may be an inexpensive speaker. Consequently, the time axis reference speaker 11FC can be implemented with only a slight cost increase compared to the conventional car audio apparatus. Moreover, the speaker 11FC can provide sufficient effects with its small structure, and thus may be installed, e.g., at the blowhole of a car air conditioner, or behind a room mirror, to make itself less conspicuous. Alternatively, the time axis reference speaker 11FC may be mounted within a casing forming the audio reproducing apparatus 20 which is installed in, e.g., the center console of the car.

While the car audio reproducing apparatus installed a car has been described as an example in the above-mentioned embodiment, the invention is not limited to applications for cars, but to any systems for reproducing similar 2-channel audio signals using at least four speakers, including home audio reproducing apparatus, to obtain similar advantages.

Moreover, the high-pass filter 25 and the attenuator 26 are used as circuitry for processing the audio signal for supply to the time axis reference speaker 11FC. However, if a speaker unit used as the speaker 11FC has an output performance ready for processing equivalent to the filtering and the attenuation, the processing by the above circuitry may be omitted. Alternatively, a delay section for introducing delay to the output of the center speaker (speaker 11FC) by a predetermined time may be provided to allow variable setting of the audio signal.

Furthermore, the audio reproducing apparatus so far described may not be used exclusively as a system dedicated to 2-channel audio signal reproduction, but may be used also as a system switchable to a multi-channel audio reproducing apparatus such as a 5.1-channel audio reproducing apparatus. That is, if, e.g., the reproducing apparatus having the above configuration is used as an audio apparatus for 5.1 channel reproduction, the speaker 11FC having the configuration of FIG. 1 may also be used as a center-channel speaker for 5.1 channel audio signals.

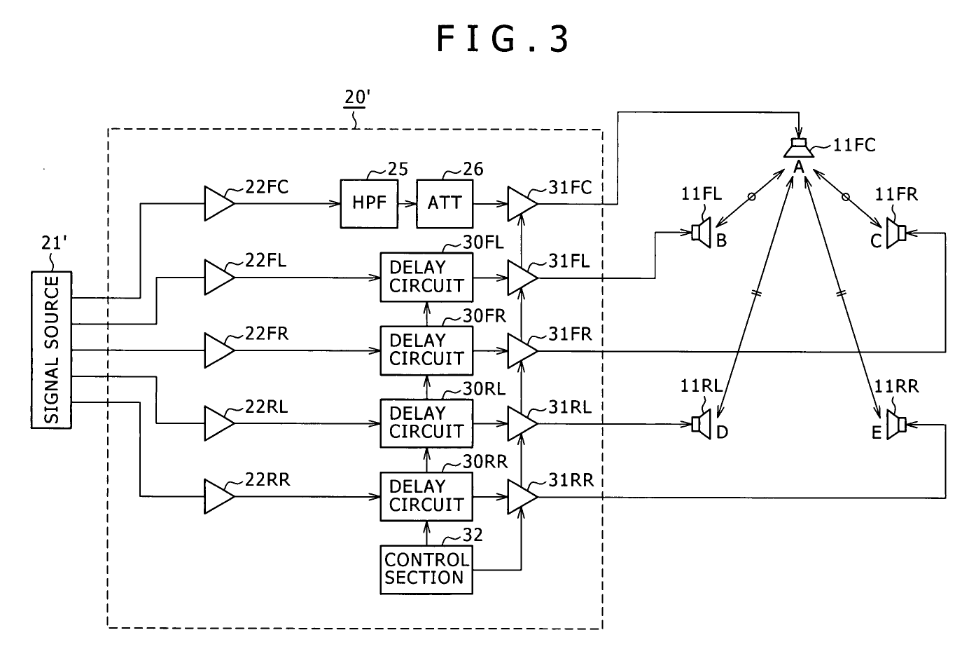

Referring here to FIG. 3, an example to which the present invention is applied to 5.1-channel audio signal reproduction will be described. FIG. 3 shows an exemplary internal configuration of a car audio reproducing apparatus 20′ designed for reproducing 5.1 channel audio signals. However, processing for a subwoofer channel is omitted, and only processing for 5 channels except the subwoofer channel is shown. In FIG. 3, the same reference symbols are given to parts corresponding to those of FIG. 2 already described. A signal source 21′ reproduces and outputs 5.1 channel audio signals. The signal source 21′ supplies center-channel, front left-channel, front right-channel, rear left-channel, rear right-channel audio signals to preamplifiers 22FC, 22FL, 22FR, 22RL, 22RR, individually. The audio signals of the respective channels amplified by the preamplifiers 22FL-22RR are delayed by a predetermined time by delay circuits 30FL-30RR, and the resultant signals are then supplied to amplifiers 31FL-31RR, for output from speakers 11FL-11RR as sounds. Moreover, a center-channel audio signal amplified by the preamplifier 22FC has its high frequency components extracted by a high-pass filter 25, then attenuated by an attenuator 26. Then, the resultant signal is amplified by an amplifier 31FC, for output from a speaker 11FC as sounds.

As a result of the connection for such processing, even 5-channel (5.1-channel) audio signal reproduction can be performed easily. If the connection configuration of FIG. 2 and the connection configuration of FIG. 3 are designed to be easily switchable by, e.g., selecting a switch position, reproduction of the audio signals of the respective channels can be switched easily. In the configuration of FIG. 3, it is applied the configuration in which the audio signal to be supplied to the speaker 11FC is extracted its high frequency components by the high-pass filter 25, which is the configuration for processing the 2-channel audio signal processing, and then attenuated by the attenuator 26. However, when reproduction is switched to 5-channel (5.1-channel) audio signal processing, that audio signal may be supplied to the speaker 11FC without passing through the high-pass filter 25 and the attenuator 26.

It should be understood by those skilled in the art that various modifications, combinations, sub-combinations and alterations may occur depending on design requirements and other factors insofar as they are within the scope of the appended claims or the equivalents thereof.

The present invention contains subject matter related to Japanese Patent Application JP2005-145716, filed in the Japanese Patent Office on May 18, 2005, the entire contents of which being incorporated herein by reference.

What is claimed is:

1. An audio reproducing apparatus for reproducing audio signals of two or more channels including at least a left-channel audio signal and a right-channel audio signal, comprising:
a mixing section for mixing the left-channel audio signal and the right-channel audio signal into an audio signal, for supply to a center speaker;
a first delay section for delaying the left-channel audio signal by a first delay time, for supply to a front left speaker;
a second delay section for delaying the left-channel audio signal by a second delay time, for supply to a rear left speaker;
a third delay section for delaying the right-channel audio signal by the first delay time, for supply to a front right speaker; and
a fourth delay section for delaying the right-channel audio signal by the second delay time, for supply to a rear right speaker,
wherein the center speaker is disposed frontward of the front left speaker and the front right speaker; the front left speaker and the front right speaker are disposed approximately symmetrical with respect to a centerline passing through the center speaker, at a first distance from the center speaker; and the rear left speaker and the rear right speaker are disposed approximately symmetrical with respect to the centerline at a second distance larger than the first distance, from the center speaker.

2. The audio reproducing apparatus according to claim 1, wherein the audio signal outputted from the mixing section is attenuated to a predetermined level and supplied to the center speaker.

3. The audio reproducing apparatus according to claim 1, wherein the audio signal outputted from the mixing section is passed through a high-pass filter for passing high-frequency components and an attenuator for attenuating a signal level to a predetermined level and supplied to the center speaker.

4. The audio reproducing apparatus according to claim 1,
wherein the center speaker is made of a speaker smaller in size than the front left speaker and the front right speaker.

5. The audio reproducing apparatus according to claim 1,
wherein the first and second delay times used at the first to fourth delay sections are variable.

6. The audio reproducing apparatus according to claim 1, further comprising a fifth delay section for delaying the audio signal by a predetermined delay time, for supply to the center speaker.
